(19) United States
(12) Patent Application Publication
(10) Pub. No.: US 2022/0414800 A1
(43) Pub. Date: Dec. 29, 2022

(54) AUTOMATED RECREATIONAL VEHICLE PARK

(71) Applicant: Linden Capital LLC, Charlotte, NC (US)

(72) Inventor: Andrew O. Falvey, Charlotte, NC (US)

(73) Assignee: Linden Capital LLC, Charlotte, NC (US)

(21) Appl. No.: 17/852,076

(22) Filed: Jun. 28, 2022

Related U.S. Application Data
(60) Provisional application No. 63/216,325, filed on Jun. 29, 2021.

(51) Int. Cl. G06Q 50/06; G06Q 50/12; G06Q 10/02; G06Q 20/18; G07C 9/20; G07C 9/10; H04N 7/18

(52) U.S. Cl. CPC G06Q 50/06; G06Q 50/12; G06Q 10/02; G06Q 20/18; G07C 9/20; G07C 9/10; H04N 7/181; G06Q 2240/00

(57) ABSTRACT

An automated vehicle park includes a site, a utility supply at the site, and an automated access control system to control access to the site by a guest. The automated access control system is configured to receive an access request associated with the site, determine if the access request is valid, and if the access request is valid, provide access to the utility supply at the site.

### CROSS-REFERENCE TO RELATED APPLICATION

This application claims the benefit of and priority to U.S. Provisional Application No. 63/216,325, filed Jun. 29, 2021, the disclosure of which is incorporated by reference herein in its entirety.

### BACKGROUND

The present disclosure relates generally to recreational vehicle (RV) parks. The present disclosure relates more particularly to automated systems and methods for operating RV parks.

Over 11% of U.S. households own a recreational vehicle, and in total more than 25 million Americans use an RV annually. To accommodate RV travelers on overnight or multi-day trips roadside parks and campgrounds have been built along well-traveled routes. At their minimum, RV parks are organized parking lots, but many offer basic amenities and utility hookups such as electricity, water, sewer, cable, and/or internet for a nominal fee. To keep the price of a stay reasonable RV parks generally provide few other services, but full hookup RV parks generally require an attendant to facilitate guest check-in, park operation, and maintenance, and attendant payroll costs can be a significant part of an RV park's operational budget. The high cost of providing an on-site attendant can lead a park operator to provide fewer services or open fewer parks, thereby diminishing the quality and quantity of services available to RV campers. Automating an RV park to allow automatic check-in and utility provisioning will lower the operation cost for a RV park and allow for more services to be provided at a lower rate.

### SUMMARY

One implementation of the present disclosure is an automated vehicle park including a site, a utility supply at the site, and an automated access control system to control access to the utility supply at the site by a guest. The automated access control system is configured to receive an access request associated with the site, determine if the access request is valid, and, if the access request is valid, provide access to the utility supply at the site.

In some embodiments, the automated access control system is further configured, if the access request is not valid, to block access to the utility supply at the site.

In some embodiments, the utility supply includes a plurality of utility supplies and the access request includes a selection of at least one of the plurality of utility supplies, wherein the automated access control system is further configured, if the access request is valid, to provide access to the selection of utilities supplies at the site. In some embodiments, the plurality of utility supplies includes at least one of an electric supply, a water supply, a cable supply, or a sewer hookup.

In some embodiments, the automated vehicle park includes a site amenity, wherein the automated access control system if further configured to provide access to the site amenity based on the access request.

In some embodiments, the automated vehicle park further includes a remote device communicably coupled to the automated access control system, and wherein the site amenity is communicatively coupled to the automated access control system, such that the remote device is configured to gain access to the site amenity via the automated access control system.

In some embodiments, the site is one of a plurality of sites in a park, the automated access control system including control kiosk located at an entrance to the park, the control kiosk including a user interface configured to receive the access request a guest stay information, and a controller configured to generate a site reservation based on the access request and transmit the site reservation to a utility kiosk located at the site and configured to control access to the utility supply at the site according to the site reservation. In some embodiments, the user interface is configured to receive the access request from an access token, the access token selected from a group consisting of a magnetized key card, a QR code, a password, or a user device. In some embodiments, the control kiosk is communicatively connected to the utility kiosk via a first wired connection and a second wireless connection, wherein the control kiosk is further configured to transmit the site reservation to the utility kiosk via the first wired connection, and transmit the site reservation to the utility kiosk via the second wireless connection if the first wired connection failed to deliver the site reservation to the utility kiosk.

In some embodiments, the site is one of a plurality of sites in a park, and the automated access control system includes a gate located at an entrance to the park and movable between an open state and a closed state, wherein the open state provides access to the park by a vehicle and the closed state blocks access to the park by a vehicle and a control kiosk communicably coupled to the gate. The control kiosk is configured to receive the access request, determine if the access request is valid, and if the access request is valid, command the gate to the open state and provide access to the utility supply at the site, and if the access request is not valid, command the gate to the closed state and block access to the utility supply at the site.

In some embodiments, the automated vehicle park further includes a remote device communicatively connected to the automated access control system over a network, wherein the remote device is configured to receive the access request, and transmit the access request to the automated access control system over the network. In some embodiments, the remote device further configured to receive the guest stay information, and transmit the guest stay information to the automated access control system. The automated access control system further configured to generate a site reservation based on the guest stay information, and transmit the site reservation to the utility kiosk, the utility kiosk configured to control the utility supply according to the site reservation.

In some embodiments, the automated vehicle park further includes a security system comprising a security camera configured to provide a view of the site, wherein the automated access control system is configured to provide the view of the site from the security camera to a remote device.

Another implementation of the present disclosure is an automated access control system for an automated vehicle park, the automated access control system comprising one or more processors and one or more non-transitory computer-readable media storing instructions that, when executed by the one or more processors, cause the one or more processors to perform operations. The operations include receiving an access request from a user, determining if the access request is valid, and if the access request is valid, (1) providing the user access to at least one of a plurality of sites in the automated vehicle park and (2) rendering accessible a utility supply at the at least one of the automated vehicle park.

In some embodiments, the operations further include blocking access to the at least one of the automated vehicle park and the utility supply if the access request is not valid. In some embodiments, the utility supply includes a plurality of utility supplies, and wherein the access request includes a selection of at least one of the plurality of utility supplies, and wherein the automated access control system is further configured, if the access request is valid, to provide access to the selection of utilities supplies at the at least one of the automated vehicle park.

In some embodiments, the operations further include receiving a second access request from a second user, determining if the second access request is valid, and if the second access request is valid, (1) providing the second user access to a second site of the plurality of sites in the automated vehicle park and (2) rendering accessible a second utility supply at the second site.

In some embodiments, the operations further include receiving the access request at a control kiosk located at an entrance to the automated vehicle park, generating, at the control kiosk, guest stay information based on the access request, and transmitting the guest stay information from the control kiosk to a utility kiosk located at the second site of the plurality of sites, wherein the utility kiosk is configured to control access to the utility supply at the second site of the plurality of sites according to the guest stay information.

In some embodiments, the access request is provided from a remote device, the remote device connected to the automated access control system via a first network.

Another implementation of the present disclosure includes a method for operating an automated vehicle park. The method includes providing a site configured to accommodate a vehicle, supplying a utility to the site via a utility supply, controlling access to the site via an automated access control system including one or more processors and one or more non-transitory computer-readable media storing instructions that, when executed by the one or more processors, cause the one or more processors to perform operations. The operations include receiving an access request, determining if the access request is valid, and if the access request is valid, providing access to the utility supply at the site, and if the access request is not valid, blocking access to the utility supply at the site.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a top-down view of an automated RV park, according to an exemplary embodiment.

FIG. 2 is a block diagram of an automated RV park, according to an exemplary embodiment.

FIG. 3 is a spider diagram an automated RV park, according to an exemplary embodiment.

FIG. 4 is a drawing of a control kiosk of an automated RV park, according to an exemplary embodiment.

FIG. 5 is a block diagram of a control kiosk of an automated RV park, according to an exemplary embodiment.

FIG. 6 is a drawing of a site of an automated RV park, according to an exemplary embodiment.

FIG. 7 is a drawing of the equipment of the parking site shown in FIG. 6, according to an exemplary embodiment.

FIG. 8 is a block diagram of a utility hookup of an automated RV park, according to an exemplary embodiment.

FIG. 9 is a flow chart illustrating the check-in process for an automated RV park, according to an exemplary embodiment.

FIGS. 10A and 10B are a flowchart illustrating the utility provisioning process for an automated RV park, according to an exemplary embodiment.

FIG. 11 is a block diagram of an automated RV park, according to another exemplary embodiment.

FIG. 12 is a drawing of a water supply for use in an automated RV park, according to an exemplary embodiment.

Like reference numbers and designations in the various drawings indicate like elements.

### DETAILED DESCRIPTION

### Overview

Before turning to the FIGURES, it should be understood that the disclosure is not limited to the details or methodology set forth in the description or illustrated in the figures. It should also be understood that the terminology is for the purpose of description only and should not be regarded as limiting.

Referring generally to the FIGURES, an automated RV park is described. The proposed solution provides an automated RV park including full utility hookup and amenity access without the need for dedicated on-site attendants, to provide an easier-to-use and cost-effective RV park. An RV park is, in general, an area designed to accommodate recreational vehicles and provide the recreational vehicles with various services (e.g., power, water, wastewater handling, internet access, etc.). A RV park can, in some cases, accommodate Class A, Class B, and/or Class C vehicles, as well as conventional motor vehicles and travel trailers. An automated RV park may include devices configured to automatically control, monitor, and manage systems and equipment in the park. An automated RV park may include an access control system, a utility provisioning system, a security system, a lighting system, and/or various amenities desirable to transient consumers or any combination thereof. A park may include a corresponding mobile application for allowing park users to interact with the various automated systems and amenities on the user's personal devices. An automated RV park may be capable of operating automatically without the need for on-site personnel.

The automated RV park may include a plurality of sites configured to accommodate a vehicle such as an RV and an automated access control system for controlling access to the sites. The automated access control system may also include a control kiosk configured to control the provisioning of utilities. Additionally, an automated RV park may include one or more automated utility hookups with computer-controlled access for turning on and turning off various utilities at sites within the park. An automated RV park may include as mentioned an access control system and a utility provisioning system, as well as a security system, a lighting system, and/or various amenities desirable to transient consumers or any combination thereof. The various systems and pieces of equipment in a park may be connected to a network for central access and control. An automated RV park may include a corresponding mobile application configured to connect to the network and/or the various systems and pieces of equipment individually for allowing park guests to interact with the various automated systems and amenities on the user's personal devices.

### Automated RV Park

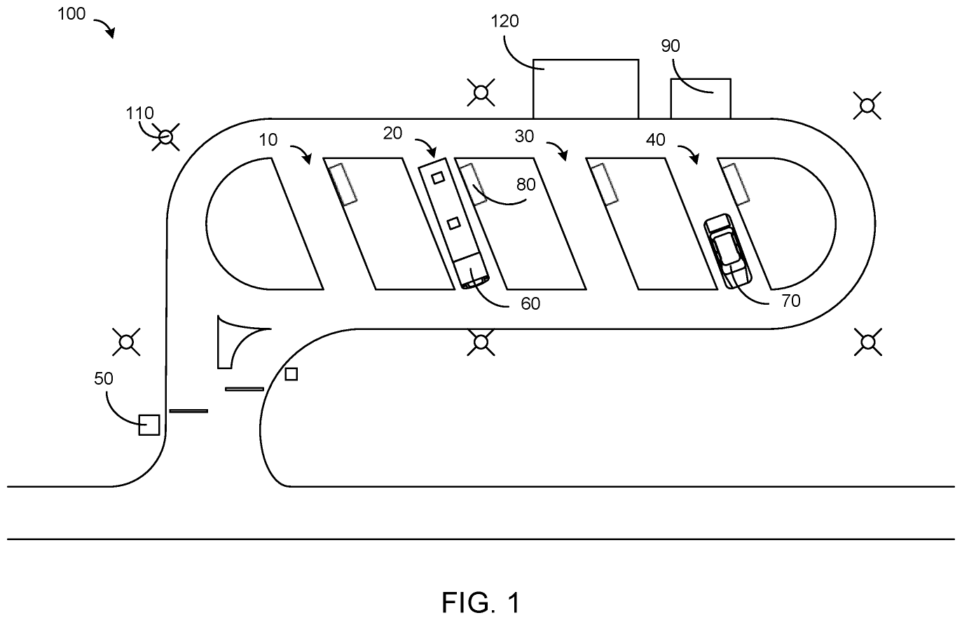

Referring now to FIG. 1, an exemplary automated RV park in which systems and methods of the present invention are implanted is shown, according to an exemplary embodiment. In FIG. 1, a top down view of a RV park 100 with a plurality of sites 10, 20, 30, and 40 is shown. Site 10 is shown as a pull-through site, in which a vehicle can enter, park, and exit without needing to change into a reverse gear. In some embodiments, site 10 is a pull-up site. In some embodiments, each site is marked by site identifier to allow guests to navigate the park.

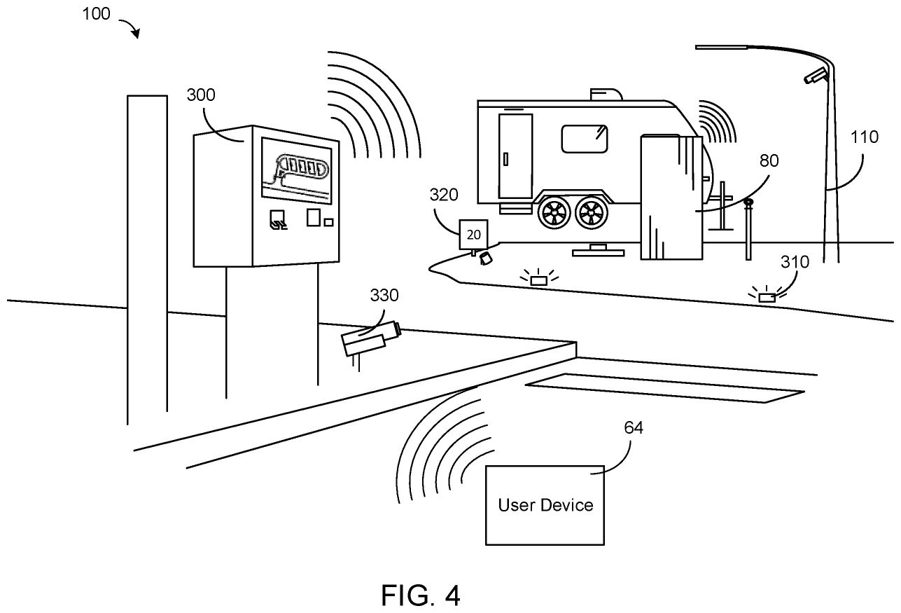

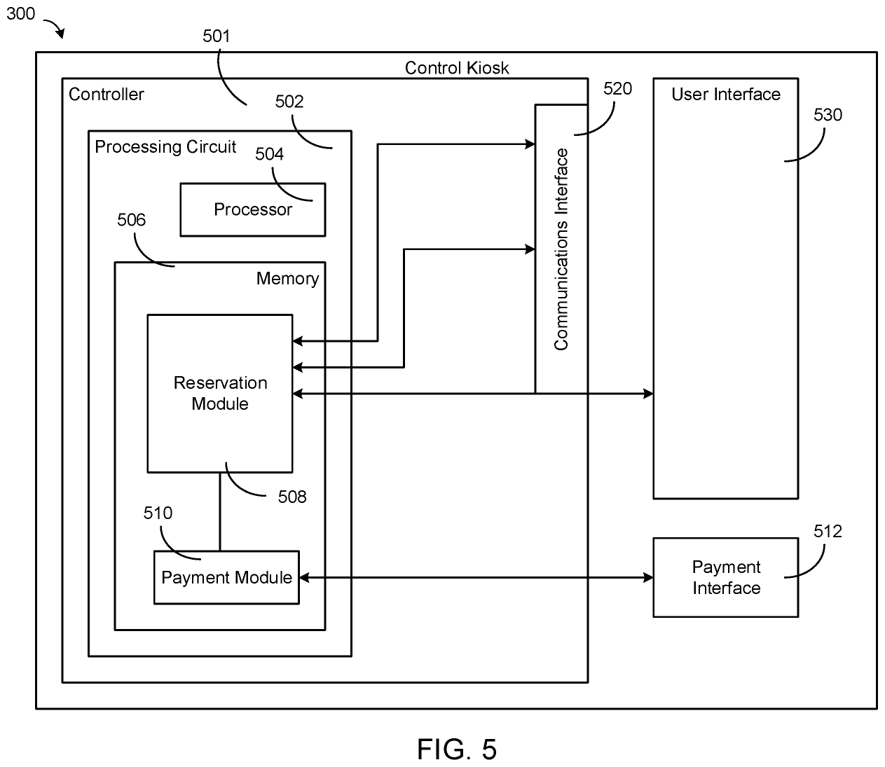

In some embodiments, access to the sites and/or the supply of a utility at a site is controlled by automated access control system 50. In some embodiments, automated access control system 50 may be configured to control access to a utility supply. In some embodiments, controlling access to a utility supply may include activating or deactivating the supply of the utility to a utility hookup (e.g., guest connection point). For example, automated access control system 50 may include a control kiosk configured to interact with a guest and provide reservation and utility provisioning services, such as activating a utility supply when a reservation begins and deactivating a utility supply when a reservation ends. In some embodiments, controlling access to a utility supply may include blocking physical access to a site where the utility supply hookups are located. For example, automated access control system 50 may include powered gate and a gate access panel, wherein the gate controls access to the sites 10, 20, 30, 40, and 50 by a vehicle. The utility supply hookups in this example may always be activated, and access to the utilities is instead controlled by controlling access to the site itself. Providing a guest access may include commanding the powered gate to open to provide a user access to the utility supply at the site. Still in other embodiments automated access control system 50 may include other means for controlling access to a utility supply. For example, utility controls for one or more sites of a park may be housed in a central access controlled room. Automated access control system 50 may unlock the central access controlled room and allow a guest to operate the utility controls to activate a utility hookup located at the guest's site. Automated access control system 50 is explained in further detail below with reference to FIGS. 4 and 5.

In some embodiments, the automated RV park 100 and each site within it are accessible by a variety of vehicles. For example, automated RV park 100 may include roads and sites sized to accommodate conventional passenger vehicles, camping trailers, Class A RVs, Class B RVs, and Class C RVs, and/or other road vehicles. For example, site 20 is shown to be occupied by a Class A RV 60, and site 40 is shown to be occupied by passenger vehicle 70.

In some embodiments, located near one or more sites (e.g., site 10, site 20) in automated RV park 100 are utility hookups, shown as utility kiosk 80. In some embodiments, each site may have a dedicated utility hookup. In some embodiments, utility hookups may only be provided to a selection of sites. In some embodiments, utility kiosk 80 includes one or more utilities. For example, the utility kiosk 80 may include electricity, water, sewer, cable access, and/or any combination thereof as well as other utilities. In some embodiments, the utility kiosk 80 may include a utility controller for controlling the supply of utilities at the site. In some embodiments, the utilities provided by utility kiosk 80 are controlled by master controls in main utility room 90, and the utility hookups at the site are simply manual connection points.

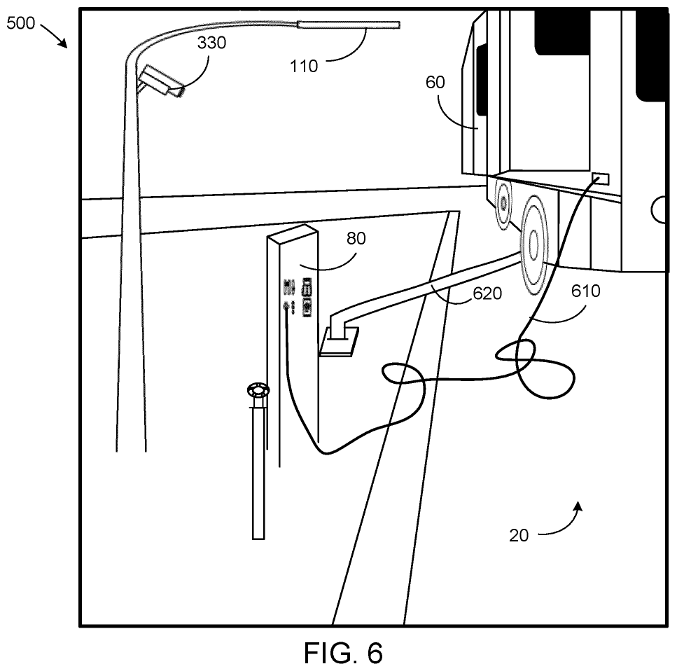

In some embodiments, the utility hookups are provided as separate units. In some embodiments, the separate units are located near a site, while in some embodiments, the separate units may be located throughout the park and/or any combination thereof. For example, an electricity hookup and a water hookup may be provided near a site, but a sewer hookup may be provided at a remote end of the park. Each individual hookup may be controlled separately via its own utility control system and include various controllers and meters required to operate the utility hookup. In some embodiments, the individual utility hookups and their associated controllers are controlled in the same manner as utility kiosk 80 is controlled. In some embodiments, access to each utility hookup is controlled independently. For example, a user with a reservation that includes a water hookup may be able to operate all water hookups located in the park. The user may be unable to operate any other type of hookup such as sewer or cable. Utility hookups and utility kiosk 80 are explained in further detail below with reference to FIGS. 6-8.

In some embodiments, automated RV park 100 includes site lighting, shown to include light 110. Light 110 may be controlled by a timer, solar alarm, motion sensor, automated access control system 50, and/or other systems and pieces of equipment in automated RV park 100. In some embodiments, light 110 turns on each night. In some embodiments, light 110 turns only when movement is sensed nearby and only for a set period of time. Light 110 allow for guests to easily access automated RV park 100 at night and to see their selected site and utility hookups. Light 110 may also illuminate various signs and important features within the park. For example, light 110 may be located to site identifiers next a site and/or located to illuminate utility kiosk 80 for a guest.

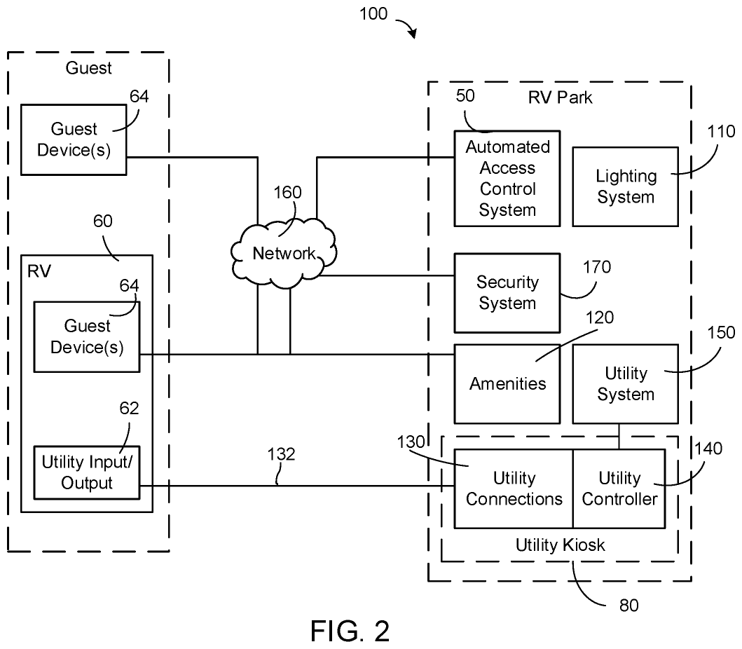

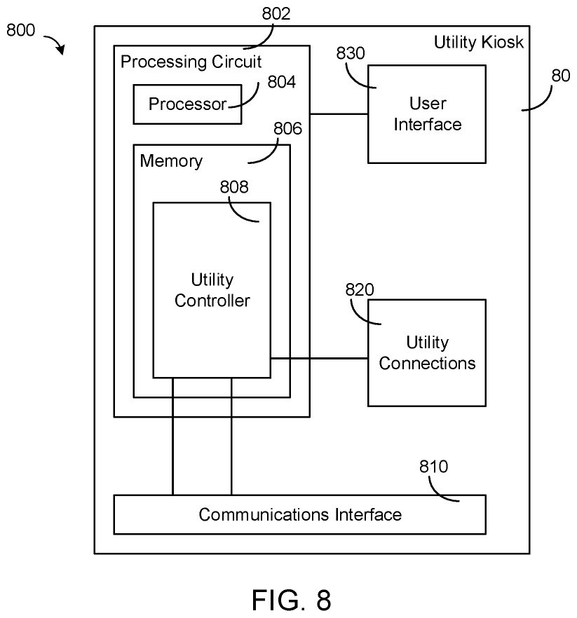

Automated RV park 100 may include various amenities for use by guest of the park. The amenities may include restrooms, laundry services, trash services, automatic vending machines (e.g., vending machines for food, drinks, toiletries, etc.,) and/or other services typically provided to or desired by guests of an RV park. For example, automated RV park 100 is shown to include amenities 120. In some embodiments, access to park amenities such as amenities 120 is restricted to guests of the park. Guests may be provided access codes and/or other conventional means for obtaining access to secured areas (e.g., digital keys, magnetized key cards, QR codes, passwords, etc.). In some embodiments, to obtain access guests may be required to unlock the amenities 120. For example, the amenities may be locked by a network controlled locked, and guests are required to input an access request on a remote device (e.g., smartphone, tablet, personal PC, etc.,) to gain access. In other embodiments, for instance when the automated access control system 50 includes a powered gate, amenities 120 may not be locked and may be provided to any person within automated RV park 100 as they have already gained access to the park. Utility access and control is explained in further detail below with reference to FIG. 2 and FIG. 8.

Referring now to FIG. 2, a block diagram of automated RV park 100 illustrating select systems and components is shown, according to an exemplary embodiment. As explained above with reference to FIG. 1, automated RV park 100 can include an automated access control system 50. In some embodiments, automated RV park 100 includes utility connections 130, utility controller 140, and utility system 150. Utility system 150 may be a park wide main utility system and/or a communication pipe/wire to the utilities used by the park. In some embodiments, utility connections 130 and utility controller 140 are components of utility kiosk 80. Utility connections 130 may be manual connection points for providing utilities to a vehicle, such as RV 60. Utility connections 130 may be connected to utility system 150. In some embodiments utility connections 130 connects to utility system 150 in main utility room 90. In some embodiments, utility system 150 runs through the park, and each utility connections 130 is a branch off of the main system. Utility connections 130 may be connected to utility controller 140. In some embodiments, utility controller 140 controllers access to utility connections 130. Utility controller 140 may be a motorized actuator and/or smart breaker for controlling the flow of a utility through utility connections 130. For example, utility controller 140 may be a breaker that controls the flow of electricity through a utility connection. Utility controller 140 may only permit the passage of electricity through utility connections 130 if authorization is received. The provisioning of utilities is explained in further detail below with reference to FIGS. 5-7.

Utility connections 130 is shown connected to utility input/output 62 of RV 60 via connection 132. In some embodiments, RV 60 may occupy a site such as site 20 of FIG. 1 without connecting to utility connections 130. In some embodiments, RV 60 may only connect to select utilities provided by utility connections 130. The connection 132 may be a single pipe, multiple pipes, wire(s), or any combination thereof. For example, RV 60 may only connect to a water supply via a pipe and neglect to connect to a sewer.

RV 60 is shown to include guest devices 64. Guests visiting the park may bring various devices (e.g., smartphones, tablet PCs, laptops, streaming equipment, routers, etc.,) with them. For example, as shown in FIG. 2, a guest device 64 may be in RV 60 and another guest device 64 may be outside RV 60 but somewhere in automated RV park 100, for instance on the person of a guest.

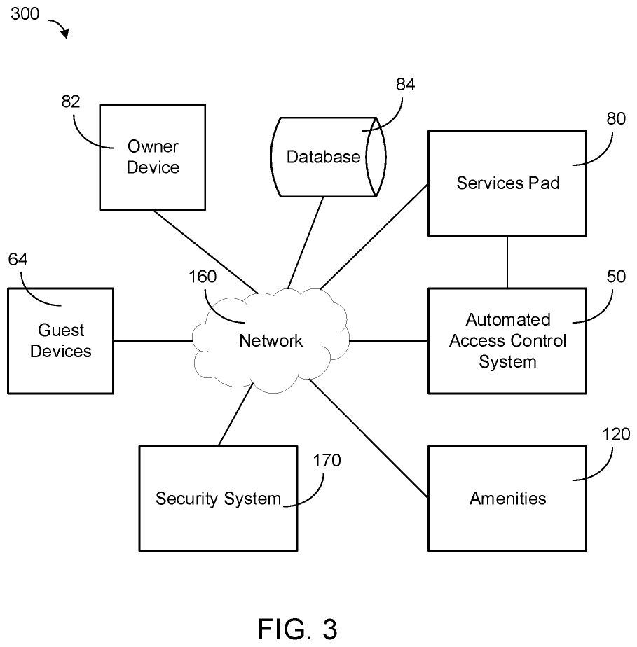

In some embodiments, guest devices 64 connect to network 160 of automated RV park 100. In some embodiments, network 160 is accessed via a wired interface as Ethernet. Referring now to FIG. 3, a spider diagram of an automated RV park is shown, according to an exemplary embodiment. In some embodiments, network 160 connects the various systems of the automated RV park 100 to each other, to various guest devices, and to an owner/operator device, shown as owner device 82. In some embodiments, network 160 is a wireless network (e.g., 3G, 4G, 5G, Wi-Fi, etc.,). In some embodiments, guest devices 64 can access various systems and components of automated RV park 100 through network 160. For example, guest devices 64 is shown connected to network 160, and in turn connected to automated access control systems 50, utility kiosk 80, amenities 120, and security system 170. In some embodiments, owner device 82 may be configured to monitor and control the operations of the automated RV park from a remote location through network 160.

In some embodiments, guest devices 64 can access other systems of automated RV park 100 through network 160 such as light or lighting system 110 and utility controller 140. Guest devices 64 may be used to operate park systems and/or view park information. For example, a guest device 64 may access security system 170 and view the images provided by various security cameras throughout the park. For example, guests may be able to view the exterior of RV 60 and the various public spaces of the automated RV park, for example the exterior of amenities 120. In some embodiments, security camera access is limited to certain cameras based on the details of the guest's reservation. For example, a guest at site 20 may be able to view security camera footage focused on site 20 but not able to view security camera footage of site 10. In some embodiments, security system 170 may alert a guest and/or the owner when suspicious and/or alarming activity occurs or when a guest is occupying a space that hasn't been paid for. For example, a security system 170 may be configured to alert an owner when a large number of people are detected near a particular site. In some embodiments, the security system 170 may access the reservation details of the guest and determine if a number of people should qualify as suspicious activity based on the number of occupants indicated in the reservation. For example, if a reservation indicates only one occupant and security system 170 detects five people near the site, security system 170 may be configured to alert the owner to the suspicious activity. Conversely, if the reservation is for five occupants and the security system 170 detects five people near the site, security system 170 may be configured not to alert the owner. In some embodiments, security system 170 may be configured to detect suspicious and/or alarming activity such as fires, overcrowding, unexpected movement (e.g., movement detected at a site with no reservation) and any other type of activity detectable by security system 170 that an owner may wish to be apprised of

In some embodiments, network 160 connects automated RV park 100 to a database 84. Control kiosk and/or utility kiosk 80 may be configured to communicate guest information, such as reservation details or billing data, to database 84 for storage and/or remote processing. For example, utility kiosk 80 may be configured to receive customer billing information and transfer that information to an accounting process (not shown) in database 84. The accounting process may be configured to process the payment and communicate with the utility kiosk 80 the result of the payment processing system. In some embodiments, the automated RV park 100 and/or subsystems (i.e., control kiosk 300, utility kiosk 80, security system 170, etc) within it may be configured to provide and receive information from a third-party data base. For example, automated RV park 100 may receive from a third-party online reservation service a reservation. The automated RV park 100 may collect billing information from a guest associated with that reservation when they arrive to the park and communicate that information to the third party third-party service. In other embodiments, the third-party service only provides reservation access and control. In some embodiments, utility kiosk 80 connects to database 84 via network 160 as shown in FIG. 3. In some embodiments, the kiosk 80 is equipped with a mobile chipset for communicating with database 84 via a 3G, 4G, and/or 5G mobile network.

In some embodiments, data may be received from a mobile device (e.g., laptop computer, tablet PC, mobile telephone). In some embodiments, the mobile device is guest device 64. In some embodiments, the data may include a reservation request, a check out notification, and/or an availability inquiry. For example, a user currently traveling towards automated RV park 100 may reserve a spot by interacting with automated RV park 100 on their mobile device through network 160. In some embodiments, the user interacts with the automated RV park 100 via network 160 using the mobile application associated with the RV park. The user can view available spots, provided utilities, prices, amenities, and local area information on the mobile application. Although the functions of control kiosk 300 and utility kiosk 80 are described separately from the functions performed on guest device 64, it is contemplated that any of the above could perform any of the functions here in described For example, a user may interact with guest device 64 to unlock a utility provided at a site. The user may be able to select which utilities to operate. For example, the user on guest device 64 may be allowed to choose what amperage is supplied to RV 60.

In some embodiments, database 84 includes a cloud-based data platform and associated user interface that a user can interact with through user interfaces of the automated RV park 100. For example, a single cloud-based application may be configured to provide the user interface for each utility kiosk in a park, and the utility kiosks may simply serve as a physical medium for a user to interact with the cloud-based application and as a platform to administer utilities from.

Database 84 may be used to store the reservation details of the guest of the park, as well as all other data collected by the park, including data from the security system 170 such as security camera footage and license plate data collected by security cameras and/or other cameras located throughout the park. The collected data may also include amongst others, use statistics, traveler tracking information (i.e., license plate data, geographic tags), time series data, and operations data. The operations data may include information pertaining to runtime and downtime for various kiosks, alerts and/or alarms for park system failures, capacity data, and more. The database 84 may itself be connected to a second database (not shown) which includes other relevant data for tracking guest behavior such as travel routes and speeds for vehicles on roads or highways surrounding the automated RV park. For example, the automated RV park may have access to a second database that indicates that a guest traveled from Connecticut to a RV site in Florida, and therefore provide an operator of the automated RV park with more information that can be paired with the collected information stored in database 84 to better track consumer behavior.

In some embodiments, guest devices 64 can connect to amenities 120 through network 160. Guest devices 64 may include a digital key that allows a guest in possession of the digital key access to amenities 120. For example, after making a reservation, a guest may be provided with a QR code that is scanned by a locking system of amenities 120. In other embodiments, guest devices 64 may be configured to run a mobile application associated with automated RV park 100. In some embodiments, the mobile application includes various features to facilitate making a reservation at automated RV park 100. For example, the mobile application may allow a guest to unlock amenities 120 over various short-range communication networks (e.g., Bluetooth, NFC, etc.,). In some embodiments, the mobile application may allow a guest to see an overview of the automated RV park 100 and available sites within the park 100. The mobile application may allow a guest to check-in and check-out of existing reservations as well as create new reservations. The mobile application can accept an input indicating desired reservation dates and times. The mobile application may provide other useful information to a guest including a listing of nearby amenities, gas stations, restaurants, other RV parks, directions to various attractions, etc. While various functions of the mobile application have been explained above, a person of ordinary skill in the art in view of the present disclosure would understand that various other functions may be controlled and/or performed on a guest's device through the mobile application to control aspects of the automated RV park.

In some embodiments, guest devices 64 running the mobile application may also interact with automated access control system 50. In some embodiments, the mobile application is connected to the automated access control system 50 of the park and serves as a user interface for automated access control system 50. In some embodiments, the mobile application and automated access control system 50 exchange data such as reservation details and access credentials. For example guests may gain access to automated RV park 100 in a similar manner to gaining access to amenities 120. For further example, automated access control system 50 may determine that a guest device 64 has a current reservation and provide access to the automated RV park 100 to the guest.

Referring now to FIG. 4, a perspective view of a control kiosk 300 for use in the automated RV park of FIG. 1 is shown, according to an exemplary embodiment. In some embodiments, automated access control system 50 includes a control kiosk, shown as control kiosk 300. In some embodiments, automated access control system 50 includes a powered gate and gate control panel for controlling access to the park and in turn the utility hookups within the park. In some embodiments control kiosk 300 is a check-in and point-of-sale (POS) system at the entrance of automated RV park 100 for allowing guests to check-in and out of preexisting reservations and to create reservations. In some embodiments, control kiosk 300 may provide guests with a visual representation of the automated RV park 100 and available sites, such as sites 10, 20, 30, 40 and 50 of FIG. 1 on a display of the control kiosk 300. In some embodiments, the security system of the park, shown as security camera 330, monitors the license plate of all vehicles entering and exiting the park, and may store the information in database 84 of FIG. 2. In some embodiments, a guest is registered according to an identifier such as their license plate number and/or vehicle make and model as entered by the guest or determined by the control kiosk from the images of security camera 330.

In some embodiments, guests can check-in to a pre-existing reservation or create a reservation at control kiosk 300. For example, a guest with a pre-existing reservation may confirm to control kiosk 300 that they have made a reservation (e.g., providing a confirmation number, QR code, operate a mobile application associated with the automated RV park 100, etc.,). In some embodiments, guests can use control kiosk 300 to modify the details of an existing reservation. In some embodiments, guests interact with control kiosk 300 to create a reservation. A reservation may include information such as a selected site, chosen utilities, a stay duration, vehicle identifying information, number of occupants, and/or any other information useful to a RV park. In some embodiments, once a reservation is created/confirmed, control kiosk 300 may send a signal to a utility kiosk to turn on the chosen utility supplies at that kiosk as indicated in the reservation. In some embodiments, the signal may be sent to a main utility control room, such as main utility control room 90 of FIG. 1, and the utility supply for the user's reserved site may be controlled from there.

In some embodiments, network 160 includes a Wi-Fi network for guests. For example, upon making a reservation a guest may be provided a Wi-Fi password to access network 160 on guest devices 64. Network 160 may include multiple modems throughout the site to provide each guest with reliable speeds for streaming, web browsing, etc. In some embodiments, network 160 includes a satellite link to establish connection between network 160 and the internet.

Still referring to FIG. 4, in some embodiments reflectors 310 may be provided throughout the site to provide directional information to a guest in poor lighting conditions. In some embodiments, reflectors 310 include lights to increase their visibility. In some embodiments, each site in automated RV park 100 is indicated by a site identifier, such as sign 320. Sign 320 may include lights so that it may also be view in poor lighting conditions.

Referring now to FIG. 5, a block diagram of a control kiosk 300 for use in an automated RV park of FIG. 1 is shown, according to an exemplary embodiment. In some embodiments, control kiosk 300 includes controller 501 for operating control kiosk 300 and controlling the activation and deactivation of the one or more utility supplies included in control kiosk 300. Controller 501 is shown to include processing circuit 502 including a processor 404 and memory 506. Processing circuit 502 can be communicably connected to communications interface 520 such that processing circuit 502 and the various components thereof can send and receive data via interface 520. Processor 504 can be implemented as a general purpose processor, an application specific integrated circuit (ASIC), one or more field programmable gate arrays (FPGAs), a group of processing components, or other suitable electronic processing components.

Memory 506 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 506 can be or include volatile memory or non-volatile memory. Memory 506 may include database components, object code components, script components, or any other type of information structure for supporting the various activities and information structures described in the present application. According to some embodiments, memory 506 is communicably connected to processor 504 via processing circuit 502 and includes computer code for executing (e.g., by processing circuit 502 and/or processor 504) one or more processes described herein.

Still referring to FIG. 5, memory 506 is shown to include reservation module 508 and payment module 510. Modules 508-510 can be configured to receive data from communications interface 520, user interface 530, and/or payment interface 512. Reservations module 510 can be configured to provide the check-in and reservation services of control kiosk 300 as described above with reference to FIG. 4. Payment module 510 may be configured to receive payment details from payment interface 512. In some embodiments, user interface 530 is a touchscreen display for displaying park information and receiving user inputs. In some embodiments, user interface 530 includes a display and a user interface system such buttons, switches, keypads, etc., for a guest to interact with control kiosk 300. In some embodiments, communications interface 520 is configured to connect control kiosk 300 to a network, such as network 160 of FIG. 4. Communications interface 520 may also be configured to receive information, such as reservation details from a guest device.

In some embodiments, communications interface 520 may be configured to send and receive messages (e.g., SMS, email, HTTP, etc.) with a guest device, such as guest device 64. For example, when a guest reserves a site a text message may be sent with pertinent information about the park and an invitation to download the park's associated mobile app. In some embodiments, a message may be sent after check-in to gauge the satisfaction levels of the guest and provide aid if needed. In some embodiments, a message is sent after guest check-out to thank the guest, suggest future RV parks on their route, request the guest complete a survey, etc.

Referring now to FIG. 6, a drawing of a site of the automated RV park 100 of FIG. 1 is shown, according to an exemplary embodiment. RV 60 is shown connected to utility kiosk 80 via electricity 610 and sewer 620. Near site 20 is shown security camera 170 and lighting system 110. In some embodiments, security camera 170 and/or another camera in the automated RV park may be used to track the movement of guests in and out of the park. For example, arrival and departure times may be logged and indexed according to guest identifiers such as a license plate number. License plate numbers may be collected by the cameras and used to generate a database of guests including information such as license plate state and county. In some embodiments, RV 60 is connected via water and/or cable hookups. In some embodiments, lighting system 110 provides light to a guest for interacting with utility kiosk 80.

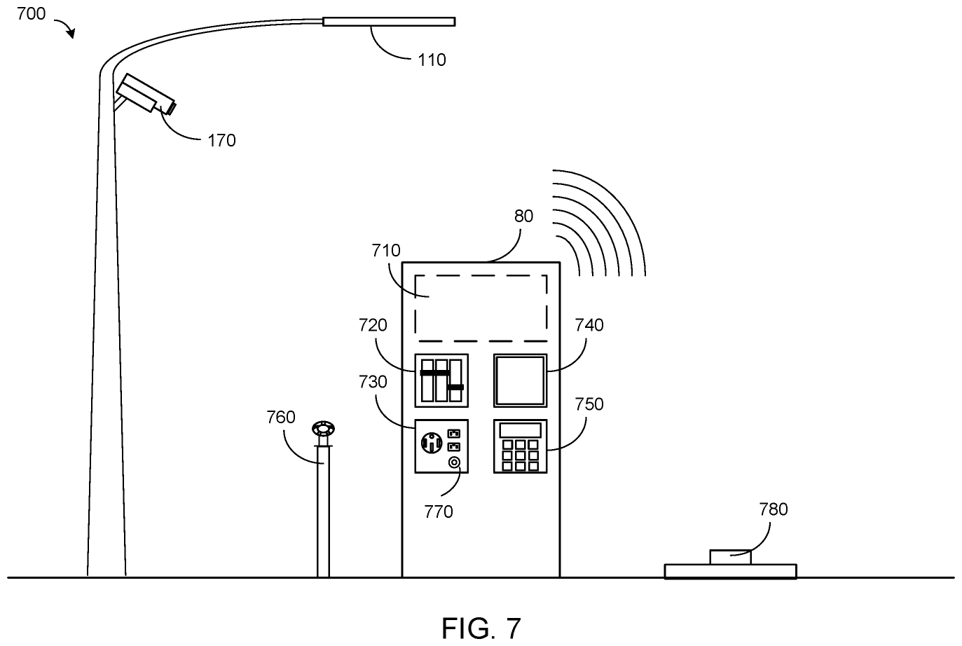

Referring now to FIG. 7, a drawing of the various pieces of equipment at a site in an automated RV park 100 of FIG. 1 is shown, according to an exemplary embodiment. As discussed above, near a site may be lighting system 110 and security camera 170. A site may also include a utility kiosk 80. Although the functions of control kiosk 300 and utility kiosk 80 are described separately it is contemplated that either kiosk could have any of the functions described. For example, the utility kiosk may be configured to make reservations and receive payment from a user. In some embodiments, utility kiosk 80 includes various utility supplies (e.g., electric 730, water 760, cable 770, and sewer 780). In some embodiments, utility kiosk 80 includes control unit 710 for controlling the operation of the utility kiosk 80. In some embodiments, utility kiosk 80 includes a display, shown as display 740, for displaying to a guest park information. Park information may include marketing information, billing information, and/or reservation details such as selected utilities, time left on reservation, amount of utilities consumed, etc., and/or other information necessary or desirable to communicate to a guest. In some embodiments display 740 is a touchscreen display for accepting a guest input. In some embodiments, utility kiosk 80 includes a user interface, shown as keypad 750. While shown as a keypad, it should be understood that the user interface of utility kiosk 80 may be any user interface capable of accepting user inputs such as a touchscreen display, buttons, switches, levers, and/or any combination thereof. In some embodiments the user interface includes other means for receiving an input from a user. In some embodiments, the user input correlates to a user activating and/or initializing one or more utility supplies in utility kiosk 80.

In some embodiments, the utility supplies at utility kiosk 80 are activated and deactivated automatically. For example, a utility supply may be activated when a reservation begins, and deactivated when a reservation ends. For further example, a control kiosk at the entrance to the park may give access to a guest with an active reservation. The control kiosk, such as control kiosk 300 of FIG. 4, may validate that the active reservation provides a user access to a site and/or one or more utility hookups at the site and may send a signal to utility kiosk 80 to activate the various hookups associated with the reservation. In some embodiments, if the control kiosk determines the reservation is not active and/or valid, the control kiosk may block access to a utility hookup. In some embodiments, for example when a default state of the utility controller and/or hookup is for the supply of the utility to be off, blocking access to a utility hookup may not require the system to perform any further function and instead to merely maintain the default state. Still in other embodiments blocking access to a utility hookup may involve utility kiosk and/or control kiosk 300 closing a gate to the park and/or turning off the supply of a utility to a site, In general, to control the supply of a utility, various control devices such as switches, buttons, levers, pins, doors, lockable covers, sheaths, guards, breakers, valves, actuators, locks, and/or other known means for controlling the access to and any combination thereof may be connected to a programmable logic controller and activated in response to an activation signal. The utility control devices may allow the supply of the utility to be provided for the duration indicated by the reservation. For example, to control the supply of electricity through the electricity hookup 730, a smart breaker 720 located in utility kiosk 80 is switched on upon receipt of the signal from the control kiosk. Once activated a guest may then control the provided amps. In some embodiments, 20, 30 and 50 amp hookups are provided and controlled with a dial at the utility kiosk 80 (not shown). In some embodiments, the breaker 720 is located in an remote utility control room such as main utility control room 90 in FIG. 1. In some embodiments, to activate the water supply an actuator at the site is activated when allows the passage of water through the water utility hookup, shown as water hookup 760.

Similar systems control access to cable hookup 770 and sewer 780. In some embodiments, cable hookup 770 is a coaxial cable. In some embodiments, cable hookup 770 is a network connection such as an Ethernet hookup for providing internet access. In some embodiments, sewer 780 may include a ball valve configured to open when an activation signal is received. Utility control ensures that someone who has not made a reservation does not have access to the utilities. This allows for an automated RV park without the need of an attendant to monitor the site and the utility hookups. The automated utility control therefor ensures only paying guest are able to access the utilities.

In some embodiments, utility control is achieved by locking the utility hookups within a structure, such as utility kiosk 80, and unlocking the structure and providing access to the utility hookups only to a guest with a validated reservation. In some embodiments, the key to unlock the utility hookups is a password such as a numerical sequence. For example, after making a reservation a guest may be provided a confirmation number. Upon entering the confirmation number into user display 740 (e.g., a touchscreen) of utility kiosk 80 the various utilities associated with the confirmation number are activated and/or unlocked. In some embodiments, the key is contained in a mobile application that can be run on a guest's device, wherein the mobile application is configured to communicate with the utility kiosk 80 to provide access and/or unlock the utility hookups. In some embodiments, all utility control is done in a main control room. For example, the various utility control mechanisms may be located on a utility bus in a control room, which contains the utility supply line for each utility at each utility kiosk 80 in automated RV park 100. The signal to activate the selected utilities for a site may be sent to the main control room where the utilities are active, thereby providing a supply of the utilities to the utility hookups at the utility kiosk 80. While select utility control methods are shown, it should be understand by a person of skill in the art with the benefit of this disclosure that other utility control mechanisms may be used without departing from the present invention.

Referring now to FIG. 8, a block diagram of a controller 800 for use in the automated RV park of FIG. 1 is shown according to an exemplary embodiment. Controller 800 is shown to include a processing circuit 802 including a processor 804 and memory 806. Processing circuit 802 can be communicably connected to communications interface 810 such that processing circuit 802 and the various components thereof can send and receive data via interface 810. Processor 804 can be implemented as a general purpose processor, an application specific integrated circuit (ASIC), one or more field programmable gate arrays (FPGAs), a group of processing components, or other suitable electronic processing components.

Memory 806 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 806 can be or include volatile memory or non-volatile memory. Memory 806 may include database components, object code components, script components, or any other type of information structure for supporting the various activities and information structures described in the present application. According to some embodiments, memory 806 is communicably connected to processor 804 via processing circuit 802 and includes computer code for executing (e.g., by processing circuit 802 and/or processor 804) one or more processes described herein.

Memory 806 is shown to include utility controller 808. In some embodiments, utility controller 808 is configured to control the operation and/or supply of utilities to utility hookups, shown as utility connections 820. Utilities controller 808 may be configured to receive an activation signal through communications interface 810 and initiate the supply of utilities through the utilities connections 820. In some embodiments, the activation signal is received from a control kiosk of the park, such as control kiosk 300. In some embodiments, the activation signal is received from directly from a guest device such as guest device 64. Still in other embodiments the activation signal is received through user interface 830. As explained in greater detail above, utilities controller 808 of utility kiosk 80 may include breakers, valves, switches, etc. to control the supply of utilities through utility connections 820 at the site.

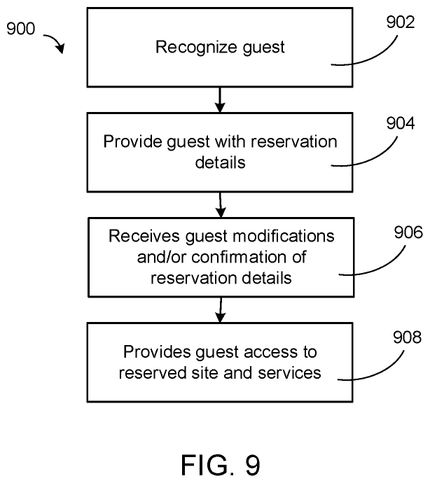

Referring now to FIG. 9, a flowchart is shown illustrating the check-in process, according to an exemplary embodiment. Process 900 may be performed by one or more components of automated RV park 100 such as control kiosk 300 and/or utility kiosk 80. Check-in process 900 is shown to include recognizing a guest (step 902). For example, control kiosk 300 may be configured to recognize a guest based on a confirmation code or other information provided by a guest to the control kiosk 300 through a user interface of the control kiosk 300. In some embodiments, a process 900 includes recognizing a guest based on the license plate of the vehicle that the guest is in, using for example security camera 330 of FIG. 4. In some embodiments, a process 900 recognizes a guest based on a signal or some other information provided by a mobile application running on the guest's device.

Check-in process 900 is shown to include providing a guest with reservation details (step 904). In some embodiments, the reservation details may be provided on a user interface of the control kiosk. In some embodiments, the reservation details may be transmitted to and displayed on the guest devices through a message (e.g., SMS, email, etc.) and/or through the mobile application. In some embodiments, the reservation details may be display on utility kiosk 80. In some embodiments, the reservation details include information such as a selected site, selected utilities, a stay duration, nearby attractions and/or amenities, and other information useful to a park guest.

Check-in process 900 is shown to include receiving guest modifications and/or confirmation of reservation details (step 906). In some embodiments, a guest may wish to modify a pre-existing reservation. For example, a guest may wish to add a sewer hookup to the reservation. In some embodiments, the modification is to the selected site or the stay duration. In some embodiments, the control kiosk is configured to receive the modification and/or confirmation of the reservation details and transmit the necessary changes to the services pad, main utility control room, amenities, etc. In some embodiments, the guest provides the modification to step 906 using the guest's device and the mobile application.

Check-in process 900 is shown to include providing the guest access to a reserved site and services (step 908). In some embodiments, access is provided by transmitting a signal to the utility kiosk associated with a selected site to activate the supply of utilities to the site's hookups. For example, a signal may be sent from a control kiosk to a motor actuator at a site to move a valve (e.g., butterfly valve, ball valve, etc.) to open and allow the passage of water through to the sites water hookup. In this manner a user may be provided access to the various utilities at a site.

In some embodiments, access is provided by operating a powered gate at the entrance to the park. For example, the park may be fenced, and the entrance and exit controlled by a powered gate. In order to enter the park and use the sites and utilities, a guest must open the gate. The control kiosk may be configured to only open the gate for guests with valid reservations. In some embodiments, a guest's reservation status may be determined by reference to the license plate of the vehicle attempting to gain entry to the park. In some embodiments, the guest's reservation status may be determined by the guest providing a confirmation code or some other kind of confirmation to the control kiosk and/or a mobile application associated with the automated RV park. In some embodiments, once access is gained through the gate, no further control is needed and the utilities can be left in a constant on state as access to the utilities is controlled by the gate.

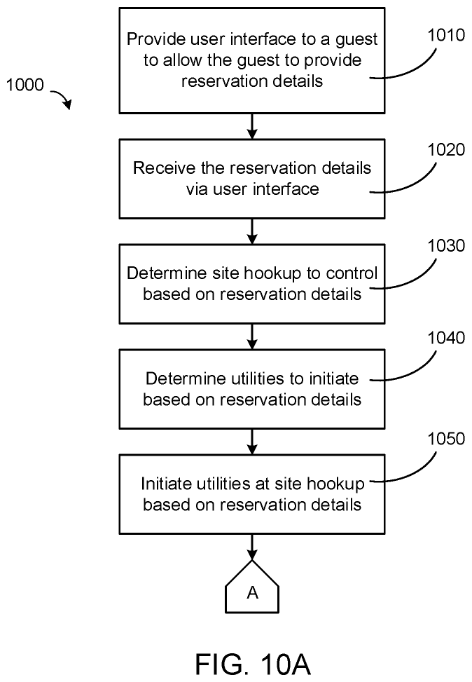

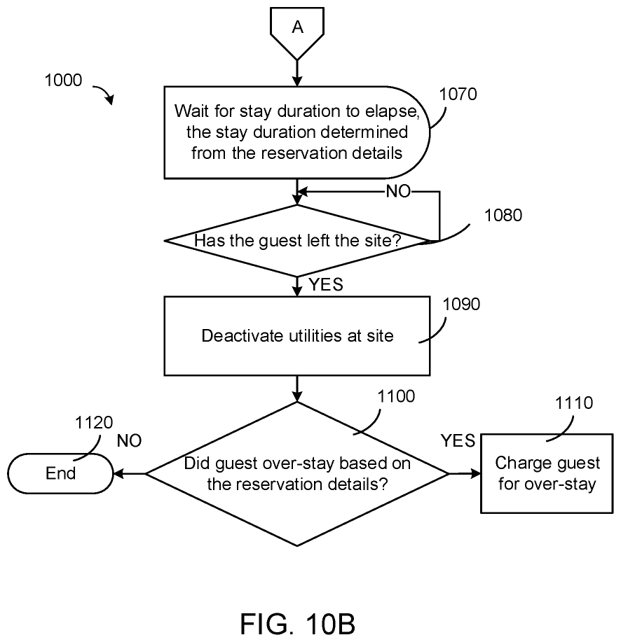

Referring now to FIGS. 10A and 10B, a flowchart illustrating the utility provisioning process is shown, according to an exemplary embodiment. Process 1000 may be performed by various components of an automated RV park 100, such as control kiosk 300 and utility kiosk 80. Process 1000 is shown to include providing a user interface to a guest to allow the guest to provide reservation details (step 1010). Step 1010 is similar and or identical to step 904 of process 900.

Process 1000 is shown to include receiving the reservation details via the user interface (step 1020). Step 1020 is similar and/or identical to step 906. In some embodiments, receiving the reservation details may include creating a new reservation for a guest, and reservation details may include selected site, selected utilities, a stay duration, nearby attractions and/or amenities, and other information useful to a park guest.

Process 1000 is shown to include determining which site hookup to control based on the reservation details (step 1030). In some embodiments, an automated RV park will contain multiple sites and a guest may only reserve a single one. Using the reservation details the control kiosk may determine which site the guest has reserved so that the control kiosk may communicate with the site's associates services pad and utility controller.

Process 1000 is shown to include determining which utilities to initiate based on the reservation details (step 1040). A site and/or utility kiosk may contain one more utility hookups. For example a utility kiosk may contain utility hookups for electricity, water, sewer, and cable. In some embodiments, guest may select to be supplied with a selected few of the total provided utilities. The control kiosk may be configured to determine which utility hookups to activate based on the reservation details provided by the gust.

Process 1000 is shown to include initiating utilities at a site hookup based on the reservation details (step 1050). In some embodiments, step 1050 is similar and/or identical to step 908 of Process 900. Initiating the utilities may include sending a signal from the control kiosk to the one more utility controllers at a site, the signal indicating to the utility controllers that the selected utility hookup should be activated. For example, the signal may indicate the electricity hookup should be activated. The utility controller for the electricity hookup may be configured to flip a breaker in response to the signal and allow electricity to pass to the electricity hookup. In some embodiments, initiating the utilities at site includes sending a signal to a main utility control room, wherein the main utility control room includes the various utility control systems for controlling a supply of utilities to a site.

Referring now to FIG. 10B, process 1000 is shown to continue, and include waiting for the stay duration to elapse, the stay duration determined from the reservation details (step 1070). In some embodiments, the stay duration is indicated in the reservation details provided by a guest. For example, a guest may indicate they plan to stay at a site for three nights. The control kiosk may be configured to ensure that for the next three nights the utilities at the selected set remain on and active.

Process 1000 is shown to include determining if the guest has left the site at the end of the stay duration (step 1080). If the guest has not left the site, process 1000 reverts back to the beginning of step 1080. If the guest has left the site, process 1000 proceeds to step 1090.

Process 1000 is shown to include deactivating the utilities at the site (step 1090). In some embodiments, the utilities are only deactivated after a guest leaves a site. This avoids the unfortunate circumstance for example of cutting cable during a broadcast that the guest is watching. In some embodiments, utilities are only deactivated when the stay duration from the reservation details has elapsed. In some embodiments, utilities are turned off depending on if another reservation is impending or if the park is experiencing an increase in demand. For example, if all remaining sites are full, and a guest is overstaying at a site and not paying, the control kiosk may cut the utilities to the site to encourage the guest to leave and thereby open a spot for a new guest.

Still in other embodiments a guest may be allowed to over-stay, and the control kiosk and/or services pad may be configured to time a guests-overstay. Process 1000 is shown to include determining if a guest over-stayed based on the reservation details. If a guest has over-stayed, process 1000 proceeds to step 1110 to charge the guest for the overstay. In some embodiments, the automated RV park may use the past payment information of the guest to automatically charge the gust for the overstay. If the guest did not overstay, process ends at step 1120.

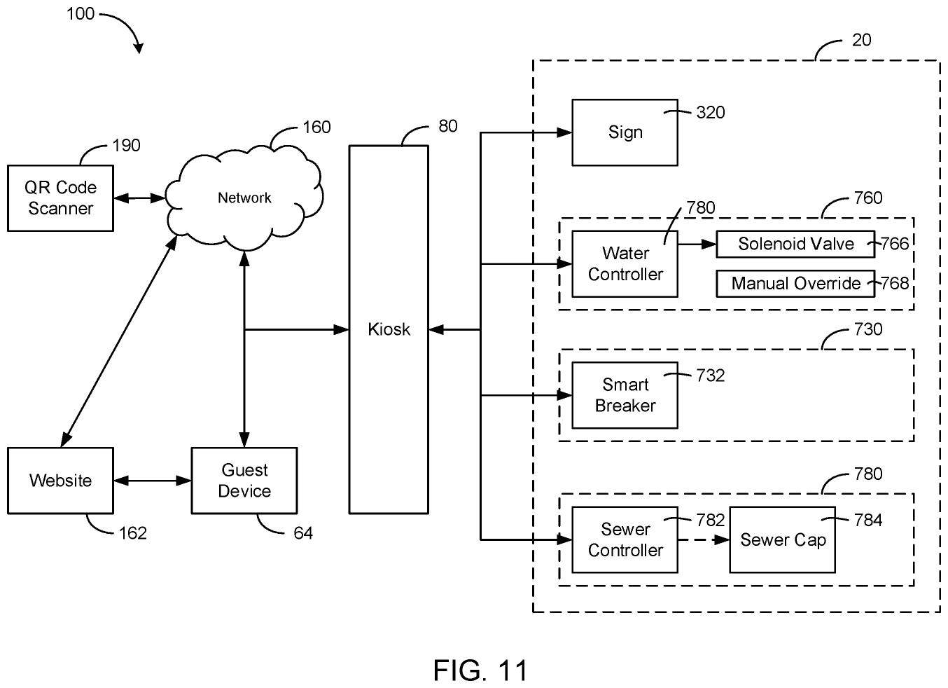

Referring now to FIG. 11, a block diagram of automated RV park 100 illustrating select systems and components is shown, according to an exemplary embodiment. In some embodiments, utility kiosk 80 is communicably coupled to a network (e.g., network 160) and a guest device (e.g., guest device 64). The network 160 can be configured to host a website, shown as website 162. Website 162 can include a graphical user interface configured to allow a user, via guest device 64 or any other personal computing device, place a reservation at the automated RV park 100. In some embodiments, after placing a reservation, guest device 64 is provided with an access code (e.g., a password, QR code, bar code, NFC tag, etc.) indicating the user has a reservation. In some embodiments, automated RV park 100 includes an access manager device, shown as QR code scanner 190, to read/receive the users access code (i.e., via the guest device 64). For example, a user with a QR code can present the QR code to QR code scanner 190. The QR code scanner 190 may authenticate/validate the QR code itself, however in some embodiments the QR code scanner 190 may communicate the QR code to the network 160 and/or the utility kiosk 80 to validate the QR code. Upon authenticating/validating the code is associated with a valid reservation, in some embodiments the utility kiosk is configured to activate/illuminate a sign, shown as sign 320. In some embodiments, sign 320 is positioned adjacent/within a site, shown as site 20. In some embodiments, sign 320 is illuminated when a reservation is activated (i.e., the guest indicates they are present at the sight by providing an access code, initiating a utility hookup, etc.). In some embodiments, sign 320 is activated in the same manner or at the same time as light 110. In some embodiments, utility kiosk 80 is configured to activate/provide access to one or more utility supplies via one or more utility hookups at a site 20 upon receiving a valid reservation (e.g., via a QR code received by QR code scanner 190). In some embodiments, the utility supplies include an electricity supply 730, water supply 760, and a sewer 780. In some embodiments, the utility supplies further include a cable/network 770 supply. The utility hookups for each utility supply may be automatically controlled by the utility kiosk 80. In some embodiments, the utility kiosk 80 merely unlocks covers to one or more utility supplies. Still in some embodiments, the utility kiosk 80 unlocks covers and/or activates the flow/provisional of utilities via the utility supply.

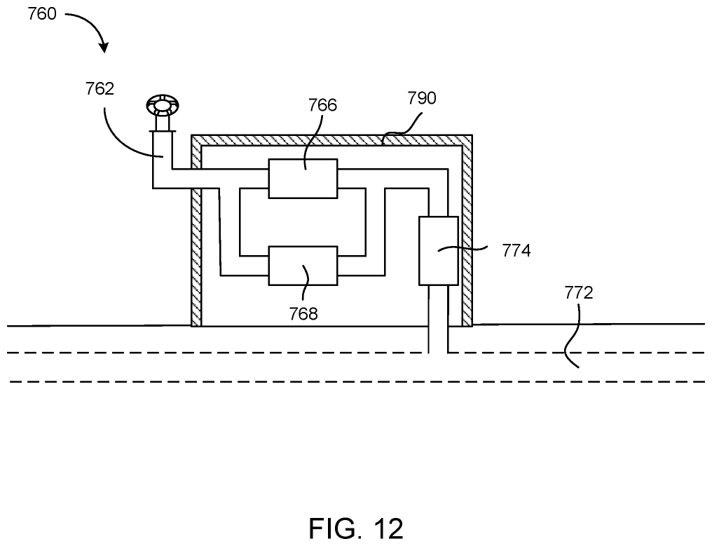

Referring still to FIG. 12, water supply 760 is shown to include a controller, shown as water controller 780. In some embodiments, water controller 780 is a component or subcomponent of controller 800. In some embodiments, water controller 780 is a separate controller comprising a similar processing circuit, processor, and memory such as those described with reference to controller 800. In some embodiments, the water controller 780 is communicably coupled to an electrically operated valve, shown as solenoid valve 766. In some embodiments water controller 780 can activate/deactivate a supply of water to the site 20 via the solenoid valve 766. In some embodiments, the water supply 760 additionally and/or alternatively includes a manually operated valve, shown as manual override 768. In some embodiments, access to manual override 768 is controlled by a manual locking system. For example, in instances where the solenoid valve 766 may fail, an operator of site 20 with access to the manual override 768 can override the water supply 760 and provide water despite the failed operation of the solenoid valve 766.

In some embodiments, electricity supply 730 includes an electrically operated breaker, shown as smart breaker 732. Smart breaker 732 is configured to control the supply of electricity to site 20 for use by a guest via the electricity supply 730. In some embodiments, a manual breaker (not shown) is additionally and/or alternatively provided, in a manner similar to manual override 768, such that in case of failure or maintenance of the smart breaker 732 an operator can nonetheless provide electricity to site 20 for the electricity supply 730.

In some embodiments, sewer 780 includes a controller, shown as sewer controller 782, to control access to/provision of sewer 780 to site 20. In some embodiments, sewer controller 782 is a component or subcomponent of controller 800. In some embodiments, sewer controller 782 is a separate controller comprising a processing circuit, processor, and memory such as those described with reference to controller 800. In some embodiments, sewer controller 782 controls the operation of an automated sewer cap, shown as sewer cap 784. Sewer cap 784 may include an actuator (e.g., a solenoid, electric actuator, rotary actuator, etc.) coupled to a cap at an access end of a sewer line. In some embodiments, the sewer controller 782 may activate the actuator to open and/or unlock the sewer cap from the sewer line and allow a guest access to the sewer line.

Referring now to FIG. 12, a cross-section of a cabinet for providing water supply 760 is shown, according to an exemplary embodiment. In some embodiments, the cabinet 790 is positioned at a site, such as site 20 in FIGS. 4, 6, and 7. In some embodiments, cabinet 790 includes a main water supply, shown as water supply 772. Water from the water supply 772 can enter the cabinet 790 and flow through a valve, shown as manual valve 774. After manual valve 774, in some embodiments, the water is split and flows through one of an electrically operated valve, shown as solenoid valve 766, or a manual valve, shown as manual override 768. In some embodiments, during normal operation the supply of water to the spigot, shown as spigot 762, is controlled by the operation of the solenoid valve 766. For example, water controller 780 (not shown) can command the solenoid valve 766 to open upon receiving a command from utility kiosk 80. In some embodiments, manual override 768 provides an alternate flow path for water to flow to spigot 762 and bypass solenoid valve 766. For example, solenoid valve 766 may fail, and an operator with access to cabinet 790 can instead activate the water supply 760 by actuating the manual override 768.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An automated vehicle park comprising:
a site;
a utility supply at the site;
an automated access control system to control access to the utility supply at the site by a guest, wherein the automated access control system is configured to:
receive an access request associated with the site;
determine if the access request is valid; and
if the access request is valid, provide access to the utility supply at the site.

2. The automated vehicle park of claim 1, wherein the automated access control system further configured, if the access request is not valid, to block access to the utility supply at the site.

3. The automated vehicle park of claim 1, wherein the utility supply comprises a plurality of utility supplies, and wherein the access request comprises a selection of at least one of the plurality of utility supplies, and wherein the automated access control system is further configured, if the access request is valid, to provide access to the selection of utilities supplies at the site.

4. The automated vehicle park of claim 3, wherein the plurality of utility supplies comprises at least one of an electric supply, a water supply, a cable supply, or a sewer hookup.

5. The automated vehicle park of claim 1, further comprising:
a site amenity, wherein the automated access control system is further configured to provide access to the site amenity based on the access request.

6. The automated vehicle park of claim 1, further comprising a remote device communicably coupled to the automated access control system, and wherein the site amenity is communicatively coupled to the automated access control system, such that the remote device is configured to gain access to the site amenity via the automated access control system.

7. The automated vehicle park of claim 1, wherein the site is one of a plurality of sites in a park, the automated access control system comprising:
a control kiosk located at an entrance to the park, the control kiosk comprising:
a user interface configured to receive the access request a guest stay information; and
a controller configured to generate a site reservation based on the access request and transmit the site reservation to a utility kiosk located at the site and configured to control access to the utility supply at the site according to the site reservation.

8. The automated vehicle park of claim 7, wherein the user interface is configured to receive the access request from an access token, the access token selected from a group consisting of a magnetized key card, a QR code, a password, or a user device.

9. The automated vehicle park of claim 7, wherein the control kiosk is communicatively connected to the utility kiosk via a first wired connection and a second wireless connection, and wherein the control kiosk is further configured to:
transmit the site reservation to the utility kiosk via the first wired connection; and
transmit the site reservation to the utility kiosk via the second wireless connection if the first wired connection failed to deliver the site reservation to the utility kiosk.

10. The automated vehicle park of claim 1, wherein the site is one of a plurality of sites in a park, the automated access control system comprising:
a gate located at an entrance to the park and movable between an open state and a closed state, wherein the open state provides access to the park by a vehicle and the closed state blocks access to the park by a vehicle;
a control kiosk communicably coupled to the gate, the control kiosk configured to:
receive the access request;
determine if the access request is valid; and
if the access request is valid, command the gate to the open state and provide access to the utility supply at the site, and if the access request is not valid, command the gate to the closed state and block access to the utility supply at the site.

11. The automated vehicle park of claim 1, further comprising a remote device communicatively connected to the automated access control system over a network, the remote device configured to:
receive the access request; and
transmit the access request to the automated access control system over the network.

12. The automated vehicle park of claim 11, the remote device further configured to:
receive the guest stay information;
transmit the guest stay information to the automated access control system, the automated access control system further configured to:
generate a site reservation based on the guest stay information; and
transmit the site reservation to the utility kiosk, the utility kiosk configured to control the utility supply according to the site reservation.

13. The automated vehicle park of claim 1, further comprising a security system comprising a security camera configured to provide a view of the site, wherein the automated access control system is configured to provide the view of the site from the security camera to a remote device.

14. An automated access control system for an automated vehicle park, the automated access control system comprising one or more processors and one or more non-transitory computer-readable media storing instructions that, when executed by the one or more processors, cause the one or more processors to perform operations comprising:
receiving an access request from a user;
determining if the access request is valid; and
if the access request is valid, (1) providing the user access to at least one of a plurality of sites in the automated vehicle park and (2) rendering accessible a utility supply at the at least one of the automated vehicle park.

15. The automated access control system of claim 14, wherein, the operations further comprising blocking access to the at least one of the automated vehicle park and the utility supply if the access request is not valid.

16. The automated access control system of claim 14, wherein the utility supply comprises a plurality of utility supplies, and wherein the access request comprises a selection of at least one of the plurality of utility supplies, and wherein the automated access control system is further configured, if the access request is valid, to provide access to the selection of utilities supplies at the at least one of the automated vehicle park.

17. The automated access control system of claim 14, wherein the operations further comprise:
receiving a second access request from a second user;
determining if the second access request is valid; and
if the second access request is valid, (1) providing the second user access to a second site of the plurality of sites in the automated vehicle park and (2) rendering accessible a second utility supply at the second site.

18. The automated access control system of claim 14, the operations further comprising:
receiving the access request at a control kiosk located at an entrance to the automated vehicle park;
generating, at the control kiosk, guest stay information based on the access request; and
transmitting the guest stay information from the control kiosk to a utility kiosk located at the second site of the plurality of sites, wherein the utility kiosk is configured to control access to the utility supply at the second site of the plurality of sites according to the guest stay information.

19. The automated access control system of claim 14, wherein the access request is provided from a remote device, the remote device connected to the automated access control system via a first network.

20. A method for operating an automated vehicle park comprising:
providing a site configured to accommodate a vehicle;
supplying a utility to the site via a utility supply;
controlling access to the site via an automated access control system comprising one or more processors and one or more non-transitory computer-readable media storing instructions that, when executed by the one or more processors, cause the one or more processors to perform operations comprising:
receiving an access request;
determining if the access request is valid; and
if the access request is valid, providing access to the utility supply at the site, and if the access request is not valid, blocking access to the utility supply at the site.
